(19) United States
(12) Patent Application Publication
(10) Pub. No.: US 2020/0177075 A1
(43) Pub. Date: Jun. 4, 2020

(54) SWITCHING CONTROL CIRCUITS HAVING REDUCED CONDUCTED EMI

(71) Applicant: STELPRO DESIGN INC., Saint-Bruno-de-Montarville (CA)

(72) Inventors: Maxime CHAMPAGNE, Varennes (CA); Jimmy LEMIRE, Trois-Rivieres (CA); Mohamed BOUDOUR, Montreal-Nord (CA); Jean-François SIMARD, Farnham, (CA); Jean-Marc CYR, La Prairie (CA); Joël McNABB-BALTAR, Montreal (CA)

(21) Appl. No.: 16/699,473

(22) Filed: Nov. 29, 2019

(30) Foreign Application Priority Data
Nov. 29, 2018 (CA) 3025780

(51) Int. Cl. H02M 1/44; H02M 3/156; H02M 1/08

(52) U.S. Cl. CPC H02M 1/44; H02M 1/08; H02M 3/156

(57) ABSTRACT

The present disclosure provides a control circuit to control power to a load, a typically load being a heating element. The control circuit is preferably comprised of a switch, such as a TRIAC switch, to switch from a first state to a second state. An energy bank, such as a capacitor, is also provided, the energy bank to store energy to power a thermostat when the switch is in a non-conducting state. The control circuit is also comprised of a drive circuit to actuate the switch back and forth from the first state to the second state. The improved control circuit has been shown to have reduced conducted electromagnetic interference, which is advantageous to meet ever stricter government guidelines for circuitry conducted EMI.

### CROSS REFERENCE TO RELATED APPLICATION

The present application claims priority to Canadian Patent Application No. CA 3,025,780, entitled “Switching Control Circuits Having Reduced Conducted EMI” filed on Nov. 29, 2018, the contents of which are incorporated herein by reference in their entirety.

### FIELD

The invention relates to the field of line thermostats, and more specifically to electronic switching control circuits contained therein having reduced conducted electromagnetic interference.

### BACKGROUND

Over the last few years, thermostats have undergone significant improvements, now having more complex user-friendly interfaces with wireless capabilities. Indeed, these thermostats—whether 24V thermostats or line voltage thermostats—are known as “smart” thermostats and are now capable of connecting users wirelessly through the internet, Bluetooth™, or via other wireless means, thereby improving heating and cooling even when users are not in the dwelling. Companies such as Nuheat™ and Honeywell™ have created such line voltage smart thermostats capable of adjusting the temperature immediately in real time.

However, one of the problems with smart line voltage thermostats—and with 2-wire line voltage thermostats in general—is that they emit a large amount of conducted electromagnetic interference (EMI). Indeed, having the capability to connect wirelessly to other peripherals, or having a larger user-friendly touchscreen are factors that lead to increased current consumption. In turn, the increased current consumption requires a circuit that can perform large amounts of “power stealing”, which is circuitry that uses energy from the source to power both the load and the thermostat. Although currently nearly all line thermostats use power stealing circuitry, increased current consumption is generally related to increased power stealing. However, as known in the art, power stealing circuitry increases the amount of conducted EMI, and such conducted EMI must be kept below certain governmental norms.

Inventions such as Canadian Patent No. 2,820,477 (Houde) and U.S. Pat. No. 9,264,035 (Tousignant) have tried to reduce such conducted EMI in the control circuits for such smart thermostats.

Specifically, Houde conceived a low power and low EMI power stealing circuit for such a control device. Indeed, Houde teaches a voltage detector that monitors the zero-crossing of the line voltage. After the zero-crossing is detected, a signal is sent resulting in the actuation of a charge switch, which diverts power away from a TRIAC switch and into a charge storage device. From the charge storage device, the charge is then transferred to energize the thermostat's control circuit. In other words, power stealing occurs after the zero-line crossing detection. Once the charge storage device is fully charged, a signal is sent to transfer the line voltage to a MOSFET, which controllably lowers the line voltage towards zero volts. Once the line voltage approaches zero volts, the TRIAC is activated and brought into a conducting state. As the line voltage is already near zero, the voltage drop across the terminals of the TRIAC is not significant, which results in lower EMI. In other words, power stealing occurs after a zero-crossing detection and before the activation of the TRIAC.

Meanwhile, Tousignant teaches a power supply for use in a smart thermostat having reduced EMI. The circuit is comprised of a zero-crossing detector that monitors the line voltage and activates a TRIAC after such a zero-crossing. A MOSFET gate driving circuit is disclosed to soften the voltage transition from the charging element to the TRIAC, which reduces the voltage drop and correspondingly the EMI generated by such a circuit.

Unfortunately, there are still deficiencies in both inventions. Therefore, there is a need for a smart thermostat capable of emitting low conducted EMI that is also acceptable within prescribed norms. A circuit for such a thermostat also needs to be simpler and avoid using voltage-attenuating MOSFETs to trigger the TRIAC.

### SUMMARY

In an aspect, the present disclosure provides a control circuit to control power to a load, comprising: a switch connected to a power source, the switch configured to switch from a first non-conducting state to a second conducting state; an energy bank electrically connected to the switch, the energy bank to store energy to power a calibrator when the switch is in the first non-conducting state; and, a drive circuit electrically connected to the switch to trigger the switch from one of: the first non-conducting state to the second conducting state and the second conducting state to the first non-conducting state, wherein the drive circuit sends a trigger signal to the switch at a zero-crossing of the power source to reduce conducted electromagnetic interference of the switch.

In another aspect, a control circuit to control power to a load, comprising: a switch connected to a power source, the switch configured to switch from a first non-conducting state to a second conducting state; a drive circuit electrically connected to a detect circuit and the switch, the drive circuit and the detect circuit to trigger the switch from one of: the first non-conducting state to the second conducting state and the second conducting state to the first non-conducting state; a boost circuit electrically connected to the detect circuit to provide the necessary energy to power a calibrator when the switch is in the second conducting state; a current source circuit electrically connected to the detect circuit to provide the necessary energy to power the calibrator when the switch is in the first non-conducting state; wherein the detect circuit triggers the switch at a zero-crossing of the power source to reduce conducted electromagnetic interference of the switch.

### BRIEF DESCRIPTION OF THE DRAWINGS

The following figures serve to illustrate various embodiments of features of the disclosure. These figures are illustrative and are not intended to be limiting.

FIG. 1 is block circuit diagram of a control circuit to activate a switch according to an embodiment of the present disclosure;

FIG. 1A is a signal diagram of the sinusoidal wave output from an AC power source of the block circuit diagram of FIG. 1, according to an embodiment of the present disclosure;

FIG. 1B is a signal diagram of the toggle of the block circuit diagram of FIG. 1, according to an embodiment of the present disclosure;

FIG. 1C is a signal diagram of the switch of the block circuit diagram of FIG. 1, according to an embodiment of the present disclosure;

FIG. 2 is block circuit diagram of a control circuit to activate a switch according to another embodiment of the present disclosure;

FIG. 2A is a block circuit diagram of a switch driver of the control circuit in FIG. 2 according to another embodiment of the present disclosure;

FIG. 3 is block circuit diagram of a control circuit to activate a switch according to yet another embodiment of the present disclosure;

FIG. 3A is a block circuit diagram of a switch driver of the control circuit in FIG. 3 according to another embodiment of the present disclosure;

FIG. 4A is a signal diagram of the sinusoidal wave output from an AC power source of the block circuit diagram of FIG. 3, according to an embodiment of the present disclosure;

FIG. 4B is a signal diagram of the toggle of the block circuit diagram of FIGS. 3 and 3A, according to an embodiment of the present disclosure;

FIG. 4C is a signal diagram of the voltage applied between A1 and A2 of the switch of FIGS. 3 and 3A, according to an embodiment of the present disclosure;

FIG. 4D is a signal diagram of the switch of the block circuit diagram of FIG. 3, according to an embodiment of the present disclosure;

FIG. 4E is a signal diagram of the current source block of the block circuit diagram of FIG. 3, according to an embodiment of the present disclosure; and,

FIG. 4F is a signal diagram of the boost block of the block circuit diagram of FIG. 3, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

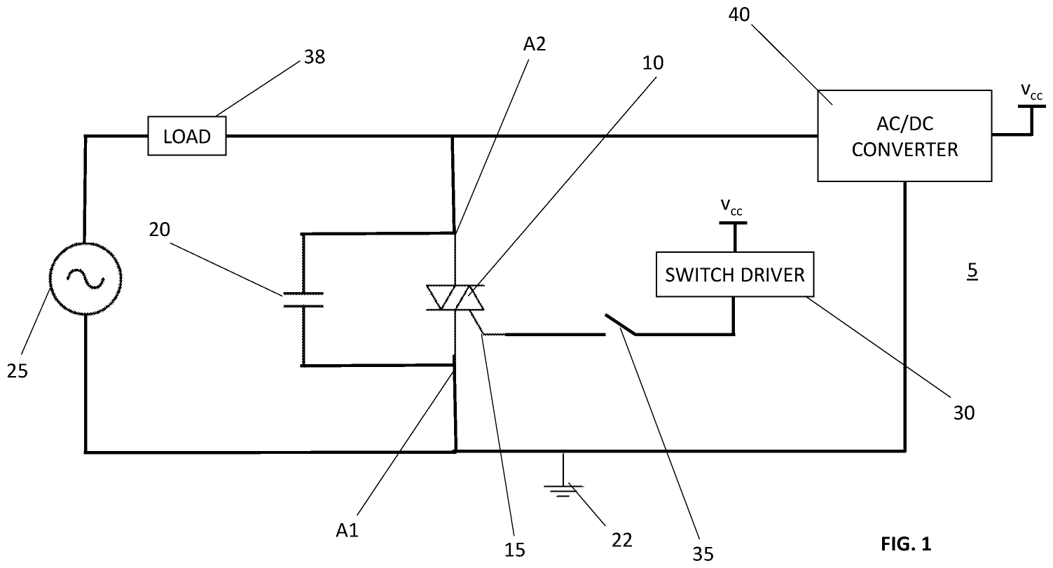

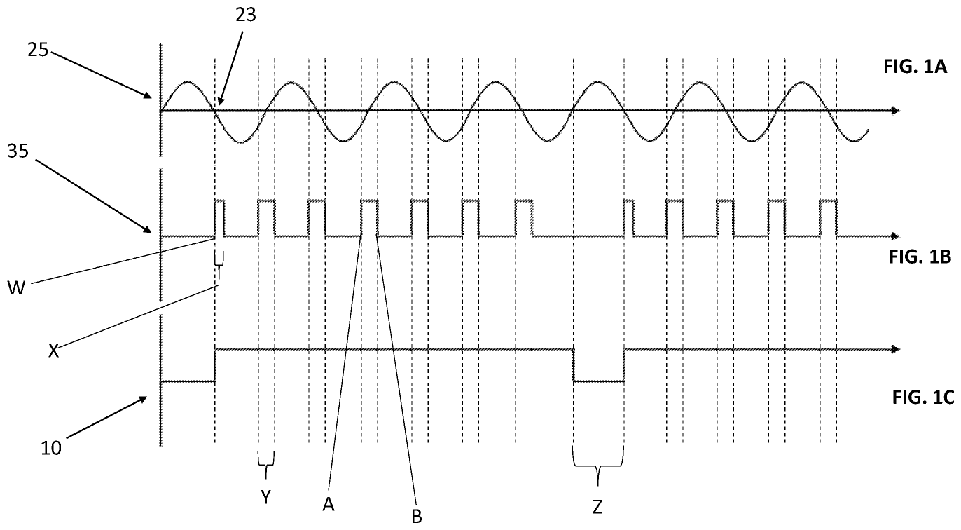

With reference to FIGS. 1, 1A, 1B and 1C and according to an embodiment of the present disclosure, a block diagram is shown to illustrate an improved control circuit 5 for activating a switch 10, and the corresponding signal diagrams are shown to depict the activation of the switch 10. A worker skilled in the art would appreciate that in a preferred embodiment, the switch 10 is a TRIAC; however, other switches, such as an IGBT, MOSFET or relay could also be used. It is known that TRIAC switches such as the switch 10 shown are comprised of first and second anodes A1, A2 also known as Main Terminal 1 (MT1) and Main Terminal 2 (MT2), respectively, and a gate 15. The switch 10 is capable of switching from a first non-conducting state to a second conducting state, depending on a current received at the gate 15, better known in the art as the trigger current. The switch 10 is shown connected in parallel with a capacitor 20. A worker skilled in the art would appreciate that such capacitor 20 connected in parallel with the switch 10 is utilized as a noise filter that will help reduce conducted emissions encountered in this type of control circuit 5. As is known in the art, such a switch 15 can be activated (i.e. triggered) in any one of the four quadrants I, I, III and IV of operation depending upon the type of switch 15 used. In the prior art, switches are triggered and therefore switch from a first non-conducting state to a second conducting state after the zero-crossing point 23 of the AC power wave generated by the source 25. Indeed, triggering the switch 15 closest to the source 25 zero-crossing point 23 reduces electromagnetic interference (EMI), which is undesirable for calibrators such as thermostats. As such, it is an object of the present disclosure to trigger the switch 15 as close as possible to the zero-crossing 23, which has been shown to further reduce the conducted EMI generated by the switch 15. In this specific embodiment as shown in FIG. 1, the switch 15 is triggered in quadrants I and IV of operation. In other words, the trigger current at the gate 15 is always positive. To do so, the control circuit 5 is further comprised of a drive circuit 30 and a toggle 35 that can open or close, therefore making or breaking the electrical connection between the switch 15 and the drive circuit 30. The drive circuit 30 is designed to monitor the voltage (and thus calculate the frequency based on the voltage) of the source 25, and to close the toggle 35, which will trigger the switch 15 at time “W”. Such time “W” is defined as being approximately at the zero-crossing 23. At this time “W”, the load 38, which is typically a heating element, begins to heat. A certain amount of time “X” later, the drive circuit 30 opens the toggle 35 and therefore current ceases to circulate to the gate 15 of the switch 10. However, the switch 10 remains active (in other words, continues to conduct) as the power from the source 25 is non-zero and the switch 10 will continue to conduct until the current between A1 and A2 of the switch 10 falls below the holding current specified for the switch 10. A worker skilled in the art would appreciate that the holding current is the current required to keep the switch 10 conducting. Again, at the certain time “X” before the next zero-crossing 23, the toggle 35 is closed for a period of time “Y”, whereby Y=X*2, thus assuring that the toggle 35 is closed during the next zero-crossing 23. Closing the toggle 35 completes the electrical connection and allows current to flow to the gate 15 of the switch 10. In turn, the switch 10 remains active and conducting for at least another half cycle of power. This process of closing the toggle 35 for a period of time “Y”, before, during and after the next zero-crossing 23 allows the switch 10 to continue to conduct electricity. Such a process is repeated for every half cycle (i.e. every zero-crossing 23) until one does not want to activate the switch 10 any longer. Indeed, during the half cycle Z that the switch 10 is not activated, the control circuit 5 is able to “power steal”; in other words, charge or recharge an energy bank (not shown), preferably in the form of a power steal capacitor (not shown) of the AC/DC converter circuit block 40 with energy from the power source 25. In turn, the energy bank (not shown) of the AC/DC converter circuit block 40 then generates a voltage V_{cc}, which is utilized to power the electrical components of the thermostat's printed circuit board (PCB). As was outlined above, the trigger current at the gate 15 of the switch 10 also comes from V_{cc} when the toggle 35 is closed, thereby activating the switch 10 in quadrants I and IV, when the gate current is positive. A worker skilled in the art would appreciate that the trigger current must be sufficiently high to linearize the intrinsic curve V(I) of the switch 15. It is important to note that the time used herein to describe the triggering of the switch 10 (at exactly the zero-crossing 23) is approximate and is not meant to be limiting. Further, in a preferred embodiment, the toggle 35 is closed at a time “A” immediately before the current in the switch 10 falls below its holding current, which is the current required to keep the switch 10 conducting. The toggle 35 is then re-opened at time “B” immediately after the current in the switch 10 has surpassed the holding current.

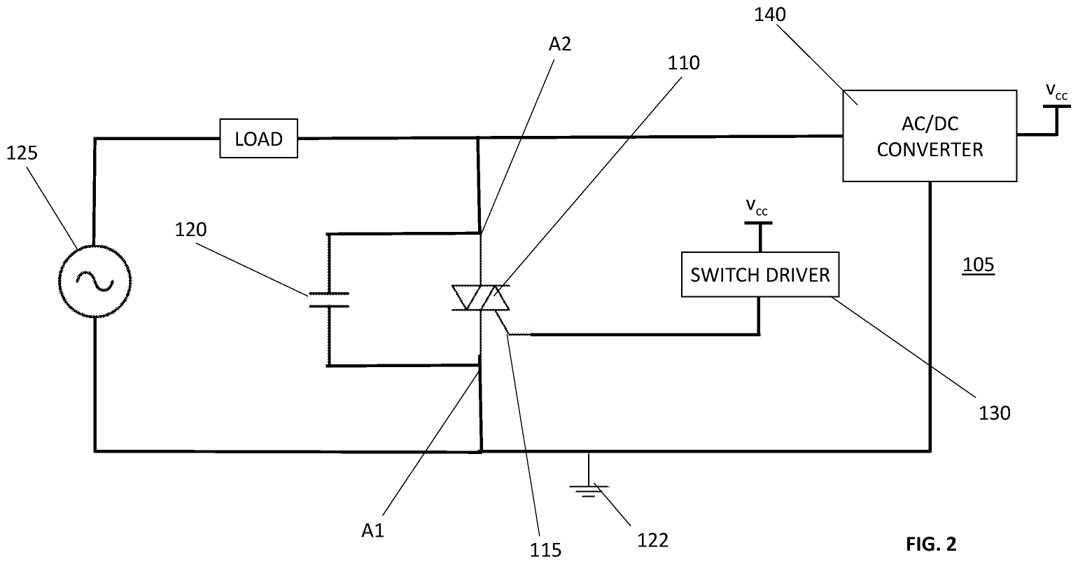

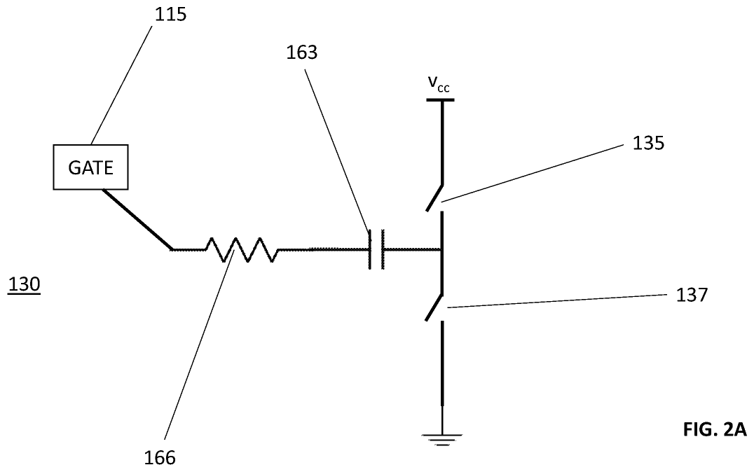

With reference to FIGS. 2 and 2A and according to an embodiment of the present disclosure, a block diagram to illustrate an improved control circuit 105 for activating a switch 110 and simplified circuit diagram for a switch driver 130 are shown. In this particular embodiment, the switch 110 is a TRIAC; however, other switches are possible. The switch 110 can alternate from a first non-conducting state to a second conducting state, depending on the trigger current received at the gate 115. The switch 110 is shown connected in parallel with an optional capacitor 120. A worker skilled in the art would appreciate that such an optional capacitor 120 may connected in parallel with the switch 110 and would be utilized as a noise filter that helps reduce conducted emissions encountered in the control circuit 105. It is once again an object of the present disclosure to trigger the switch 115 approximately at the zero-crossing, which has been shown to reduce the conducted EMI generated by the switch 115. In this specific embodiment, the switch 115 is specifically triggered in quadrants I and III of operation. A worker skilled in the art would appreciate that quadrant I is defined as having a positive current at the gate 115 and Anode 2 (A2), while quadrant III is defined as having a negative current at the gate 115 and Anode 2 (A2). It is desirous for the switch 110 to be triggered when the AC power from the source 125 is approximately at the zero-crossing, as this has been shown to reduce conducted EMI. During operation of the control circuit 105, the gate 115 of the switch 110 does not receive any current when first and second toggles 135, 137 are open. During this time, the drive circuit 130 measures the voltage (and thus calculates the frequency based on the voltage) of the source 125. At approximately the zero-crossing of the AC power from the source 125, the drive circuit 130 closes the first toggle 135, while the second toggle 137 remains open. As such, current travels from V_{cc} to the gate 115 of the switch 110 through first toggle 135, capacitor 163 and resistor 166, which charges the capacitor 163 and activates the switch 110 with a positive and sufficiently high current. As the current at A2 is also positive, the switch 110 is activated in quadrant I. After a time “X” (not shown), the first toggle 135 is reopened such that current no longer travels from V_{cc} to the gate 115. However, the switch 110 remains active (in other words, continues to conduct) as the current in between first and second anodes A1 and A2 is higher than the switch 115 holding current. A period of time “X” (not shown) before the next zero-crossing, the second toggle 137 is closed. The charged capacitor 163 begins to discharge, sending a current through the gate 115 of the switch 110, the resistor 166, capacitor 163 and the second toggle 137. As current is flowing away from the gate 115 of the switch 110 while A2 is negative, the switch 110 is triggered in quadrant III. The second toggle 137 remains closed for a period of time “Y” (not shown), whereby Y=X*2, so that the current passes through the switch 110 during the next zero-crossing. Again, at the period of time “X” (not shown) before the next zero-crossing, the first toggle 135 is closed for the period of time “Y” (not shown), and at the period of time “X” (not shown) before the next zero-crossing the second toggle 137 is closed for the period of time “Y” (not shown), until one does not want to activate the switch 110 any longer. There are two reasons not to activate the switch 110. First, to power steal and use an entire half cycle of power from the source 125 to charge an energy bank (not shown), preferably in the form of a power steal capacitor (not shown) of the AC/DC converter circuit block 140. Second, as the correct heat level has been achieved and the thermostat is no longer required to heat. In a preferred embodiment, one of the first and second toggles 135, 137 are closed at a time “A” immediately before the current in the switch 110 falls below its holding current, which is the current required to keep the switch 110 conducting. One of the first and second toggles 135, 137 are then re-opened at time “B” immediately after the current in the switch 110 has surpassed the holding current.

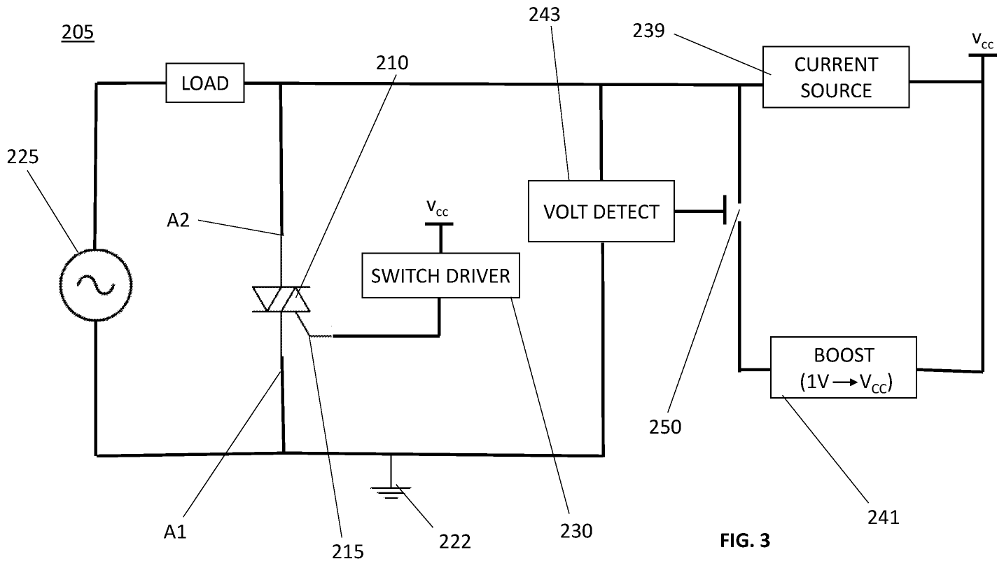

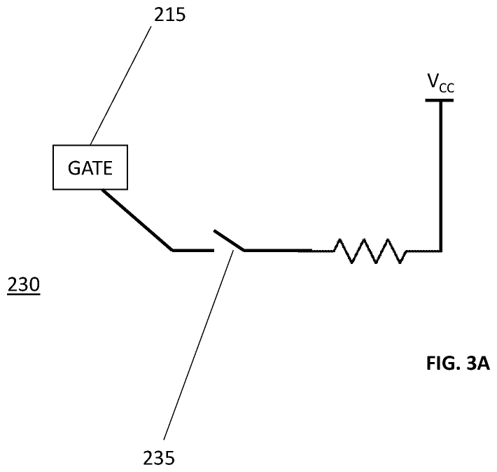

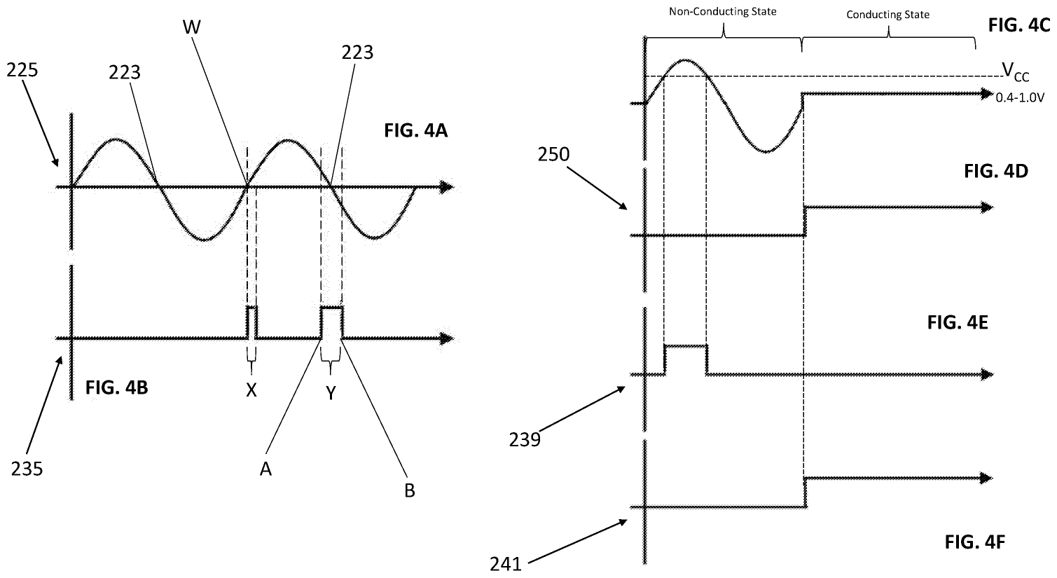

With reference to FIGS. 3, 3A, 4A, 4B, 4C, 4D, 4E and 4F and according to another embodiment of the present disclosure, a block diagram is shown to illustrate an improved control circuit 205 for activating a switch 210 and the corresponding signal diagrams are shown to depict the activation of the boost switch 250 and toggle 235. In this embodiment, the switch 210 is a TRIAC; however, other switches are possible. The switch 210 can switch from a first non-conducting state to a second conducting state, depending on the trigger current received at the gate 215. This switch 210 is specifically triggered in quadrants I and IV of operation (when the gate 215 current is positive). However, the switch 210 could be triggered in quadrants II and III of operation if the trigger current was negative. To activate the switch 210, the control circuit 205 is further comprised of a drive circuit 230 including a toggle 235 to open or close, therefore making or breaking the electrical connection between the gate 215 and the drive circuit 230. A volt detect block 243 is provided to monitor the voltage of the AC power source 225 and deduce its frequency. By monitoring the voltage of the AC power source 225, the volt detect block 243 detects zero-crossings. Indeed, a function of the volt detect block 243 is to detect zero-crossings and send a signal to close the toggle 235 at approximately the zero-crossing 223 of the source 225. As such, at the zero-crossing 223 shown at moment “W”, the toggle 235 is closed and current travels to the gate 215 of the switch 210 and the switch 210 goes from a first non-conducting state to a second conducting state. A period of time “X” later, depending on the amount of time required to achieve the requisite holding current for the switch 210, the toggle 235 is opened and thus the current ceases to circulate to the gate 215 of the switch 210. However, the switch 210 remains active (in other words, continues to conduct) as the power from the source 225 is non-zero and the switch 210 will continue to conduct until the current between A1 and A2 of the switch 210 falls below the holding current specified for the switch 210. Then a period of time “X” before the next zero-crossing, the toggle 235 is closed for a period of time Y, where Y=X*2, such that the toggle 235 is closed during the next zero-crossing 223. Closing the toggle 235 completes the electrical connection again and allows current to flow to the gate 215 of the switch 210. In turn, the switch 210 remains active and conducting for at least another half cycle of power. This process of closing the toggle 235 at a time “X” before the next zero-crossing for a period of time “Y” allows the switch 210 to continue conducting. Such a process is repeated for every half cycle (i.e. every zero-crossing 223) until one does not want to activate the switch 210 any longer. A worker skilled in the art would appreciate that the above-mentioned period of time “Y” is based on the holding current of the switch 210 so that the switch 210 remains in conduction. In other words, closing the toggle 235 at time “X” before zero-crossings 223 ensures that the current does not fall below the holding current, and re-opening the toggle 235 a period of time “Y” (i.e. “X” amount of time after the zero-crossing 223) ensures that the current is greater than the holding current. In this specific embodiment, the control circuit 205 works in two states: when the switch 210 is in a non-conducting state and when the switch 210 is in a conducting state. The conventional power stealing described for the other embodiments to recharge a capacitor is not required. Indeed, when the switch 210 is not active (i.e. in a non-conducting state), the current source block 239 can produce V_{cc}. When the voltage at the input of current source block 239 is greater than V_{cc}, current is sent to the V_{cc} output. This is specifically shown in FIG. 4C, which shows the voltage seen at A1 and A2, and FIG. 4E, which shows V_{cc} powered by the current source block 239. As the positive voltage seen at A1 and A2 is greater than V_{cc}, the current source block 239 provides V_{cc}. Meanwhile, a function of the boost block 241 is to produce V_{cc} when the switch 210 is activated, as it would otherwise be impractical and ineffective to create a switch-mode power supply circuit with an input voltage of 0.5V-339V. When the switch 210 is active (i.e. in a conducting state), the voltage seen by the switch 210 (between A1 and A2) will be limited to a voltage of approximately between 0.4V to 1.0V as specifically shown in FIG. 4C. Indeed, 0.4V to 1.0V is the voltage of the switch 210 in its conducting state. In this voltage range, the current source block 239 is not able to produce V_{cc}. As such, the volt detect block 243 activates a boost switch 250, which is preferably ideal diodes or a MOSFET. The boost switch 250 completes the connection to the boost block 241, which boosts the voltage from the 0.4-1.0V range to V_{cc}. It is this voltage V_{cc} that is utilized to power the electrical components of the thermostat's printed circuit board (PCB).

A worker skilled in the art would appreciate that the switches shown in FIGS. 1, 2 and 3 could be conceived to be activated in any one of the four quadrants of operation. However, the switches activate in specific quadrants of operation as these quadrants have been shown to generate less EMI, which is an object of the present disclosure. As mentioned above, the preferred time to close and open the toggle before and after zero-crossing (for the embodiment described in FIGS. 3 and 3A) is determined based on the load current required for the switch. In this example, a period of time “X” is preferably 500 μs, which was determined to be the optimal time for the particular TRIAC switch requiring a load current of between 1.5 A-16 A. Further, in a preferred embodiment, the toggle 235 is closed at a time “A” immediately before the current in the switch 210 falls below its holding current, which is the current required to keep the switch 210 conducting. The toggle 235 is then re-opened at time “B” immediately after the current in the switch 210 has surpassed the holding current.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A control circuit to control power to a load, comprising:
a switch connected to a power source, the switch configured to switch from a first non-conducting state to a second conducting state;
an energy bank electrically connected to the switch, the energy bank to store energy to power a calibrator when the switch is in the first non-conducting state; and,
a drive circuit electrically connected to the switch to trigger the switch from one of: the first non-conducting state to the second conducting state and the second conducting state to the first non-conducting state,
wherein the drive circuit sends a trigger signal to the switch at a zero-crossing of the power source to reduce conducted electromagnetic interference of the switch.

2. The control circuit of claim 1 further comprised of a capacitor connected in parallel to the switch to act as a noise filter and reduce conducted electromagnetic interference of the switch.

3. The control circuit of claim 1 wherein the drive circuit is further comprised of a toggle, the toggle to open and close to send the trigger signal to the switch and activate the switch in quadrants I and IV of operation.

4. The control circuit of claim 1 wherein the drive circuit is further comprised of a first toggle, a second toggle, a capacitor and a resistor, the first and second toggles configured to open and close to send the trigger signal to the switch and activate the switch in quadrants I and III of operation.

5. The control circuit of claim 3 wherein the toggle is closed for a period of time “X” before at least one zero-crossing of the power source, and for a total period of time “Y”, whereby Y=X*2.

6. The control circuit of claim 4 wherein at least one of the first and second toggles is closed for a period of time “X” before at least one zero-crossing of the power source, and for a total period of time “Y”, whereby Y=X*2.

7. The control circuit of claim 5, wherein the period of time “X” begins at a time “A”, the time “A” is defined as the immediately before a current of the switch falls below a holding current of the switch, the holding current defined as the current required to keep the switch conducting.

8. The control circuit of claim 1 wherein the energy bank forms part of a AC/DC converter circuit, the AC/DC converter circuit electrically connected to the load and the power source to provide a voltage V_{cc}.

9. A control circuit to control power to a load, comprising:
a switch connected to a power source, the switch configured to switch from a first non-conducting state to a second conducting state;
a drive circuit electrically connected to a detect circuit and the switch, the drive circuit and the detect circuit to trigger the switch from one of: the first non-conducting state to the second conducting state and the second conducting state to the first non-conducting state;
a boost circuit electrically connected to the detect circuit to provide the necessary energy to power a calibrator when the switch is in the second conducting state; and,
a current source circuit electrically connected to the detect circuit to provide the necessary energy to power the calibrator when the switch is in the first non-conducting state;
wherein the detect circuit triggers the switch at a zero-crossing of the power source to reduce conducted electromagnetic interference of the switch.

10. The control circuit of claim 9 further comprised of a capacitor connected in parallel to the switch to act as a noise filter and reduce conducted electromagnetic interference of the switch.

11. The control circuit of claim 9 wherein the detect circuit is electronically connected to the boost circuit and the current source circuit by means of a detect switch, the detect switch being one of: ideal diodes and a MOSFET.

12. The control circuit of claim 9 wherein the drive circuit is further comprised of a toggle, the toggle to open and close to send the trigger signal to the switch and activate the switch in quadrants I and IV of operation.

13. The control circuit of claim 12 wherein the toggle is closed for a period of time X before at least one zero-crossing of the power source, and for a total period of time Y, whereby Y=X*2.
